(19) United States
(12) Patent Application Publication
(10) Pub. No.: US 2026/0012900 A1
(43) Pub. Date: Jan. 8, 2026

(54) METHODS AND APPARATUS OF REPORTING PHR FOR SUPPORTING DYNAMIC WAVEFORM SWITCHING

(71) Applicant: Lenovo (Beijing) Limited, Beijing (CN)

(72) Inventors: Lingling Xiao, Beijing (CN); Bingchao Liu, Beijing (CN); Chenxi Zhu, Fairfax, VA (US); Wei Ling, Beijing (CN); Yi Zhang, Beijing (CN)

(73) Assignee: Lenovo (Beijing) Limited, Beijing (CN)

(21) Appl. No.: 19/112,362

(22) PCT Filed: Dec. 23, 2022
(86) PCT No.: PCT/CN2022/141501

§ 371 Date: Mar. 17, 2025

(51) Int. Cl. H04W 52/36; H04W 52/14

(52) U.S. Cl. CPC H04W 52/365; H04W 52/146; H04W 52/367

(57) ABSTRACT

Methods and apparatus of reporting PHR for supporting dynamic waveform switching are disclosed. The apparatus includes a receiver that receives Downlink Control Information (DCI) in an active serving cell indicating a first waveform or a second waveform for a Physical Uplink Shared Channel (PUSCH) transmission; a processor that determines a first Power Headroom Report (PHR) corresponding to the first waveform, and a second PHR corresponding to the second waveform; and a transmitter that transmits the first PHR and/or the second PHR for the active serving cell.

### FIELD

The subject matter disclosed herein relates generally to wireless communication and more particularly relates to, but not limited to, methods and apparatus of reporting Power Headroom Report (PHR) for supporting dynamic waveform switching.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Physical Downlink Control Channel (PDCCH), Physical Uplink Shared Channel (PUSCH), Binary Phase Shift Keying (BPSK), Bandwidth Part (BWP), Control Element (CE), Cyclic Prefix (CP), Downlink Control Information (DCI), Frequency Division Multiple Access (FDMA), Index/Identifier (ID), Media Access Control (MAC), Media Access Control—Control Element (MAC-CE), Modulation Coding Scheme (MCS), Quadrature amplitude modulation (QAM), Quadrature Phase Shift Keying (QPSK), Resource Block (RB), Radio Resource Control (RRC), Reference Signal (RS), Subcarrier Spacing (SCS), Time-Division Multiplexing (TDM), Transmission Reception Point (TRP), Component Carrier (CC), Dual Connectivity (DC), Discrete Fourier Transform (DFT), E-UTRA NR Dual-Connectivity (EN-DC), Frequency Range 1 (FR1), Frequency Range 2 (FR2), Maximum Power Reduction (MPR), Peak-to-Average Power Ratio (PAPR), Technical Specification (TS), Universal Terrestrial Radio Access (UTRA), Discrete Fourier Transform-spread-Orthogonal Frequency Division Multiplexing (DFT-s-OFDM), Evolved Universal Terrestrial Radio Access (E-UTRA), NR-E-UTRA Dual Connectivity (NE-DC), Universal Terrestrial Radio Access Network (UTRAN), Power Headroom Report (PHR), Cyclic Prefix Orthogonal Frequency Division Multiplexing (CP-OFDM), Path Loss (PL), Pass Loss Reference Signal (PL-RS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

Two waveforms, namely DFT-s-OFDM and CP-OFDM, are supported in NR UL transmission to utilize the advantages of different waveforms in different scenarios.

For PUSCH transmission with DFT-s-OFDM, only one layer is supported while CP-OFDM waveform may support up to eight-layer PUSCH transmission. However, the PAPR of DFT-s-OFDM waveform is lower, and thus the efficiency of a UE's power-amplifier is higher compared to CP-OFDM waveform. For example, if a UE is at a cell centric location, a PUSCH may be transmitted with CP-OFDM for higher throughput; and if a UE is at the cell edge, a PUSCH may be transmitted with DFT-s-OFDM since it provides a better coverage due to a higher power efficiency.

### SUMMARY

Methods and apparatus of reporting PHR for supporting dynamic waveform switching are disclosed.

According to a first aspect, there is provided an apparatus, including: a receiver that receives Downlink Control Information (DCI) in an active serving cell indicating a first waveform or a second waveform for a Physical Uplink Shared Channel (PUSCH) transmission; a processor that determines a first Power Headroom Report (PHR) corresponding to the first waveform, and a second PHR corresponding to the second waveform; and a transmitter that transmits the first PHR and/or the second PHR for the active serving cell.

According to a second aspect, there is provided an apparatus, including: a transmitter that transmits Downlink Control Information (DCI) in an active serving cell indicating a first waveform or a second waveform for a Physical Uplink Shared Channel (PUSCH) transmission; and a receiver that receives a first Power Headroom Report (PHR) corresponding to the first waveform and/or a second PHR corresponding to the second waveform for the active serving cell.

According to a third aspect, there is provided a method, including: receiving, by a receiver, Downlink Control Information (DCI) in an active serving cell indicating a first waveform or a second waveform for a Physical Uplink Shared Channel (PUSCH) transmission; determining, by a processor, a first Power Headroom Report (PHR) corresponding to the first waveform, and a second PHR corresponding to the second waveform; and transmitting, by a transmitter, the first PHR and/or the second PHR for the active serving cell.

According to a fourth aspect, there is provided a method, including: transmitting, by a transmitter, Downlink Control Information (DCI) in an active serving cell indicating a first waveform or a second waveform for a Physical Uplink Shared Channel (PUSCH) transmission; and receiving, by a receiver, a first Power Headroom Report (PHR) corresponding to the first waveform and/or a second PHR corresponding to the second waveform for the active serving cell.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic block diagram illustrating an example of actual PUSCH transmissions of different waveforms overlapping with the slot of transmitting the PHR in accordance with some implementations of the present disclosure;

FIG. 4B is a schematic block diagram illustrating an example for calculation of P_{CMAX} and PHR for different waveforms in accordance with some implementations of the present disclosure;

FIG. 5A is a schematic block diagram illustrating an example of one Single Entry PHR MAC-CE for PHR reporting for different waveforms in accordance with some implementations of the present disclosure;

FIG. 5B is a schematic block diagram illustrating an example of a separate Single Entry PHR MAC-CE for PHR reporting for a waveform in accordance with some implementations of the present disclosure;

FIG. 5C is a schematic block diagram illustrating an example of a separate Multiple Entry PHR MAC-CE for PHR reporting for a waveform for UE configured with multiple serving cells in accordance with some implementations of the present disclosure;

FIG. 6 is a schematic block diagram illustrating an example of Path Loss variation issue in dynamic waveforms switching in accordance with some implementations of the present disclosure;

FIG. 7 is a flow chart illustrating steps of reporting PHR for supporting dynamic waveform switching by UE in accordance with some implementations of the present disclosure; and

FIG. 8 is a flow chart illustrating steps of receiving PHR for supporting dynamic waveform switching by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

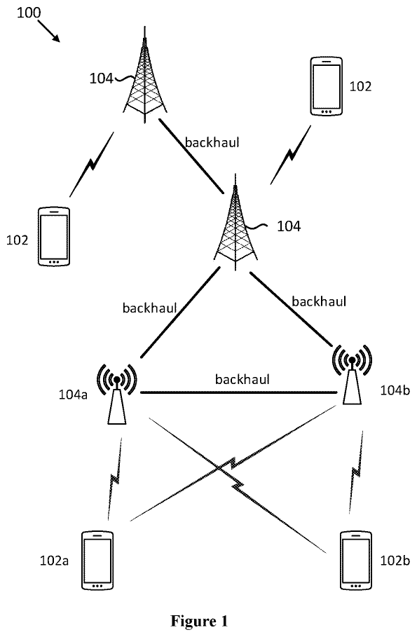

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

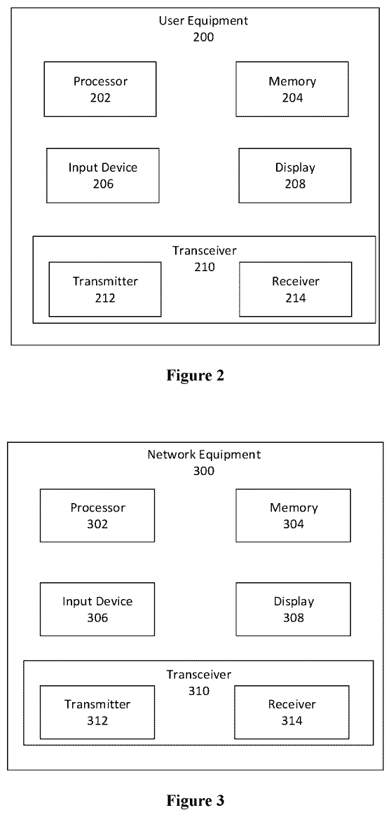

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

Two waveforms, namely DFT-s-OFDM and CP-OFDM, are supported in NR UL transmission to facilitate the advantages of different waveforms in different scenarios. If transform precoding is disabled, DFT-s-OFDM will be used for UL transmission and if transform precoding is enabled, CP-OFDM will be used. In RAN1 #110b, DCI level waveforms switching between DFT-s-OFDM and CP-OFDM was agreed to be supported, but when and how a gNB may decide to switch the waveform is still under discussion. In RAN1 #111, PHR was proposed as a candidate metric to assist gNB on waveform selection. However, current PHR is based on the configured waveform that does not support dynamic waveform switching. Enhancements on how to calculate the PHRs corresponding to the different waveforms and how to report the PHRs for different waveforms are provided in the present disclosure.

Besides, the PHR triggering event may need to be enhanced as well. For instance, if Pass Loss (PL) variation in two adjacent PHRs has changed more than phr-Tx-PowerFactorChange dB, the PHR will be trigged according to the current triggering event. But with dynamic waveform switching, if the Pass Loss Reference Signal (PL-RS) used for calculating PHRs for different waveforms is different, whether one or two PL measured based on the PL-RSs are used for determining PL variation and how to determine the PL variation are discussed in the present disclosure as well.

The following is an example of PH report as provided in the current Technical Specification TS 38.213 of 3GPP.

7.7.1 Type 1 PH report

If a UE determines that a Type 1 power headroom report for an activated serving cell is based on an actual PUSCH transmission then, for PUSCH transmission occasion i on active UL BWP b of carrier ƒ of serving cell c, the UE computes the Type 1 power headroom report as

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

where P_{CMAX,ƒ,c}(i), P_{O_PUSCH,b,ƒ,c}(j),

$${M}_{RB , b , f , c}^{PUSCH} ( i ) ,$$

α_{b,ƒ,c}(j), PL_{b,ƒ,c}(q_{d}), Δ_{TF,b,ƒ,c}(i) and ƒ_{b,ƒ,c}(i,l) are defined in clause 7.1.1.

If a UE is configured with multiple cells for PUSCH transmissions, where a SCS configuration μ₁ on active UL BWP b₁ of carrier ƒ₁ of serving cell cᵢ is smaller than a SCS configuration μ₂ on active UL BWP b₂ of carrier ƒ₂ of serving cell c₂, and if the UE provides a Type 1 power headroom report in a PUSCH transmission in a slot on active UL BWP b₁ that overlaps with multiple slots on active UL BWP b₂, the UE provides a Type 1 power headroom report for the first PUSCH, if any, on the first slot of the multiple slots on active UL BWP b₂ that fully overlaps with the slot on active UL BWP b₁. If a UE is configured with multiple cells for PUSCH transmissions, where a same SCS configuration on active UL BWP b₁ of carrier ƒ₁ of serving cell c₁ and active UL BWP b₂ of carrier ƒ₂ of serving cell c₂, and if the UE provides a Type 1 power headroom report in a PUSCH transmission in a slot on active UL BWP b₁, the UE provides a Type 1 power headroom report for the first PUSCH, if any, on the slot on active UL BWP b₂ that overlaps with the slot on active UL BWP b₁.

If a UE is configured with multiple cells for PUSCH transmissions and provides a Type 1 power headroom report in a PUSCH transmission with PUSCH repetition Type B having a nominal repetition that spans multiple slots on active UL BWP b₁ and overlaps with one or more slots on active UL BWP b₂, the UE provides a Type 1 power headroom report for the first PUSCH, if any, on the first slot of the one or more slots on active UL BWP b₂ that overlaps with the multiple slots of the nominal repetition on active UL BWP b₁.

For a UE configured with EN-DC/NE-DC and capable of dynamic power sharing, if E-UTRA Dual Connectivity PHR [14, TS 36.321] is triggered, the UE provides power headroom of the first PUSCH, if any, on the determined NR slot as described in clause 7.7.

If a UE is configured with multiple cells for PUSCH transmissions, the UE does not consider for computation of a Type 1 power headroom report in a first PUSCH transmission that includes an initial transmission of transport block on active UL BWP b₁ of carrier ƒ₁ of serving cell c₁, a second PUSCH transmission on active UL BWP b₂ of carrier ƒ₂ of serving cell c₂ that overlaps with the first PUSCH transmission if
the second PUSCH transmission is scheduled by a DCI format in a PDCCH received in a second PDCCH monitoring occasion, and
the second PDCCH monitoring occasion is after a first PDCCH monitoring occasion where the UE detects the earliest DCI format scheduling an initial transmission of a transport block after a power headroom report was triggered or
the second PUSCH transmission is after the first uplink symbol of the first PUSCH transmission minus T′_{proc,2}=T_{proc,2} where T_{proc,2} is determined according to [6, TS 38.214] assuming d_{2,1}=1, d_{2,2}=0, and with μ_{DL} corresponding to the subcarrier spacing of the active downlink BWP of the scheduling cell for a configured grant if the first PUSCH transmission is on a configured grant after a power headroom report was triggered.

If the UE determines that a Type 1 power headroom report for an activated serving cell is based on a reference PUSCH transmission then, for PUSCH transmission occasion i on active UL BWP b of carrier ƒ of serving cell c, the UE computes the Type 1 power headroom report as

$${PH}_{type \text{?} , f , c} ( i , j , {q}_{d} , l ) = {\tilde{P}}_{CMAX , f , c} ( i ) - \{ {P}_{O \_ PUSC \text{?} , f , c} ( j ) + {α}_{b , f , c} ( j ) \cdot {PL}_{b , f , c} ( {q}_{d} ) + {f}_{b , f , c} ( i , l ) \} [ dB ]$$

$$\text{?} \text{indicates text missing or illegible when filed}$$

where \tilde{P}_{CMAX,ƒ,c}(i) is computed assuming MPR=0 dB, A-MPR=0 dB, P-MPR=0 dB. ΔT_{C}=0 dB. MPR, A-MPR, P-MPR and ΔT_{C} are defined in [8-1, TS 38.101-1], [8-2, TS38.101-2] and [8-3, TS 38.101-3]. The remaining parameters are defined in clause 7.1.1 where P_{O_PUSCH,b,ƒ,c}(j) and α_{b,ƒ,c}(j) are obtained using P_{O_NOMINAL,PUSCH,ƒ,c}(0) and p0-PUSCH-AlphaSetId=0, PL_{b,ƒ,c}(q_{d}) is obtained using pusch-PathlossReferenceRS-Id=0, and l=0.

If a UE is configured with two UL carriers for a serving cell and the UE determines a Type 1 power headroom report for the serving cell based on a reference PUSCH transmission, the UE computes a Type 1 power headroom report for the serving cell assuming a reference PUSCH transmission on the UL carrier provided by pusch-Config. If the UE is provided pusch-Config for both UL carriers, the UE computes a Type 1 power headroom report for the serving cell assuming a reference PUSCH transmission on the UL carrier provided by pucch-Config. If pucch-Config is not provided to the UE for any of the two UL carriers, the UE computes a Type 1 power headroom report for the serving cell assuming a reference PUSCH transmission on the non-supplementary UL carrier.

If a UE transmits a PUSCH associated with a RS resource index q_{d}, as described in clause 7.1.1, on active UL BWP b of carrier ƒ of serving cell c in slot n and provides a Type 1 power headroom report for an actual PUSCH repetition associated with the RS resource index q_{d}, the Type 1 power headroom report is for the first PUSCH repetition associated with the RS resource index q_{d} that overlaps with slot n.

If a UE transmits a PUSCH associated with a first RS resource index q_{d}, as described in clause 7.1.1, on active UL BWP b of carrier ƒ of serving cell c in slot n and is provided twoPHRMode, the UE provides a Type 1 power headroom report for PUSCH repetition associated with a second RS resource index q_{d}, as described in clause 7.1.1, where
if the UE provides a Type 1 power headroom report for an actual PUSCH repetition associated with the first RS resource index q_{d},
   if the UE transmits PUSCH repetitions associated with the second RS resource index q_{d} in slot n, the UE provides a Type 1 power headroom report for a first actual PUSCH repetition associated with the second RS resource index q_{d} that overlaps with slot n
   otherwise, the UE provides a Type 1 power headroom report for a reference PUSCH transmission associated with the second RS resource index q_{d}
otherwise, if the UE provides a Type 1 power headroom report for a reference PUSCH transmission associated with the first RS resource index q_{d}, the UE provides a Type 1 power headroom report for a reference PUSCH transmission associated with the second RS resource index q_{d}

The following is an example of UE maximum power reduction as provided in the current Technical Specification TS 38.101 of 3GPP.

6.2.2.3 UE maximum output power reduction for power class 3

For power class 3, MPR for contiguous allocations is defined as:

$$MPR = max ( {MPR}_{WT} , {MPR}_{narrow} )$$

For transmission bandwidth configuration less than or equal to 200 MHz, and 0≤RBₛₜₐᵣₜ<Ceil (⅓ N_{RB}) or Ceil((⅔N_{RB})−L_{CRB})≤RBₛₜₐᵣₜ N_{RB}−L_{CRB}:
MPR_{narrow}=2.5 dB, when BW_{alloc,RB} is less than or equal to 1.44 MHz,
MPR_{narrow}=2.0 dB, when 1.44 MHz<BW_{alloc,RB}<=4.32 MHz,
otherwise MPR_{narrow}=0 dB.

MPR_{WT} is the maximum power reduction due to modulation orders, transmission bandwidth configurations listed in Table 5.3.2-1, and waveform types. MPR_{WT} is defined for FR2-1 in Table 6.2.2.3-1.

TABLE 6.2.2.3-1
MPR_{WT} for power class 3, BWchannel ≤ 200 MHz, FR2-1

| | | MPR_{WT}, BW_{channel} ≤ 200 MHz | |
|---|---|---|---|
| | | Inner RB allocations, | Edge RB |
| Modulation | | Region 1 | allocations |
| DFT-s-OFDM | Pi/2 BPSK | 0.0 | ≤2.0 |
| | QPSK | 0.0 | ≤2.0 |
| | 16 QAM | ≤3.0 | ≤3.5 |
| | 64 QAM | ≤5.0 | ≤5.5 |
| CP-OFDM | QPSK | ≤3.5 | ≤4.0 |
| | 16 QAM | ≤5.0 | ≤5.0 |
| | 64 QAM | ≤7.5 | ≤7.5 |

MPR_{WT} is defined for FR2-2 in Table 6.2.2.3-1b.

TABLE 6.2.2.3-1b
MPR_{WT} for power class 3, BWchannel = 100 MHz, FR2-2

| | | MPR_{WT}, BW_{channel} = 100 MHz | |
|---|---|---|---|
| | | Inner RB allocations, | Edge RB |
| Modulation | | Region 1 | allocations |
| DFT-s-OFDM | Pi/2 BPSK | [0.0] | [≤2.0] |
| | QPSK | [0.0] | [≤2.0] |
| | 16 QAM | [≤3.0] | [≤3.5] |
| | 64 QAM | [≤5.0] | [≤5.5] |
| CP-OFDM | QPSK | [≤3.5] | [≤4.0] |
| | 16 QAM | [≤5.0] | [≤5.0] |
| | 64 QAM | [≤7.5] | [≤7.5] |

### PHR Calculation for Each Waveform

A Type 1 UE power headroom (PH) indicates the difference between the UE configured maximum transmit power P_{CMAX} and the required power for a PUSCH transmission in an activated BWP of a Serving Cell that assumes there is no upper limit on the transmit power for the PUSCH transmission. A Type 1 PHR can be calculated based on an actual PUSCH transmission, i.e., an actual PHR, or based on a reference PUSCH transmission, i.e., a virtual PHR.

If a UE determines that a Type 1 power headroom report for an activated BWP of a serving cell is based on an actual PUSCH transmission, then the UE computes the Type 1 power headroom report, namely the actual PHR, as

$$P {H}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ] , \qquad ( 1 )$$

where P_{CMAX,ƒ,c}(i), P_{O_PUSCH,b,ƒ,c}(j),

$${M}_{RB , b , f , c}^{P U S C H} ( i ) ,$$

α_{b,ƒ,c}(j), PL_{b,ƒ,c}(q_{d}), Δ_{TF,b,ƒ,c}(i) and ƒ_{b,ƒ,c}(i, l) are defined in clause 7.1.1 of TS 38.213 v17.3.0.

If a UE determines that a Type 1 power headroom report is based on a reference PUSCH transmission, then the UE computes the Type 1 power headroom report, namely the virtual PHR, as

$${PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ] , \qquad ( 2 )$$

where \tilde{P}_{CMAX,ƒ,c}(i) is computed assuming MPR=0 dB, A-MPR=0 dB, P-MPR=0 dB. ΔTC=0 dB. MPR, A-MPR, P-MPR and ATC are defined in TS 38.101-1, TS 38.101-2 and TS 38.101-3.

P_{CMAX} is the UE configured maximum output power which is calculated by the UE with certain MPR values according to TS38.101. Two waveforms, i.e., CP-OFDM and DFT-s-OFDM, are supported for PUSCH transmission in NR Rel-15. DFT-s-OFDM only supports single layer transmission for coverage limitation scenario, while CP-OFDM supports multi-layer PUSCH transmission for higher data rate transmission. Further, different P_{CMAX} values may be determined for CP-OFDM and DFT-s-OFDM according to TS38.101, since for PUSCH transmission with different waveforms, the modulation schemes, RB allocation may be different. For PHR calculation based on an actual PUSCH transmission, the parameter Δ_{TF,b,ƒ,c}(i) in equation (1) may also be different for different waveforms since it is determined by the indicated modulation scheme, the number of allocated RBs and the number of layers for the scheduled PUSCH.

Waveform specific PHR is introduced to assist a gNB on dynamic waveform selection. The following three cases are considered for the calculation of each P_{CMAX} and PH corresponding to a different waveform.

### Case 1: There are Actual PUSCH Transmissions With Both of the Different Waveforms Overlapping With the Slot of the PHR Report

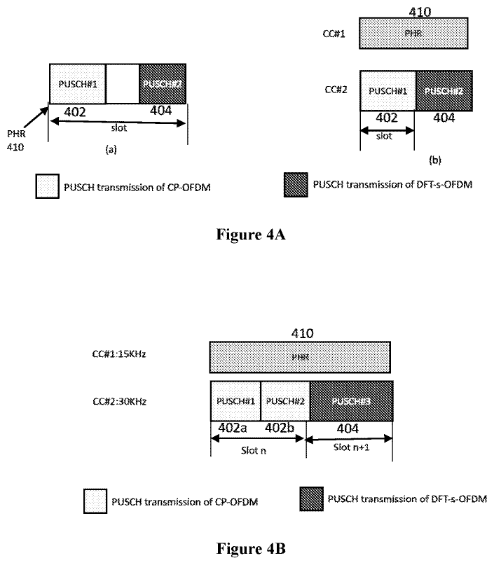

FIG. 4A is a schematic block diagram illustrating an example of actual PUSCH transmissions of different waveforms overlapping with the slot of transmitting the PHR in accordance with some implementations of the present disclosure.

For the case there are actual PUSCH transmissions with CP-OFDM and DFT-s-OFDM overlaps with the slot in which the PHR is transmitted, the P_{CMAX} and the PH for CP-OFDM and DFT-s-OFDM may be calculated based on the corresponding actual PUSCH transmissions of the respective waveforms. That means the formula (1) is used to calculate the actual PHR for the different waveforms and the parameters in formula (1) are determined by the actual PUSCH transmission with the corresponding waveform. If there are multiple actual PUSCH transmissions corresponding to a waveform that overlap with the slot in which the PHR is transmitted, the P_{CMAX} and the PH are calculated based on the first PUSCH transmission of the waveform that overlaps with the slot of the PHR report. The first PUSCH transmission can be the PUSCH with the earliest start symbol among those PUSCH transmissions that overlap with the slot of the PHR report.

FIG. 4A illustrates the case where there is an actual PUSCH transmission 402 with CP-OFDM (i.e., PUSCH #1) and an actual PUSCH transmission 404 with DFT-s-OFDM (i.e., PUSCH #2) that overlap with the slot for the PHR transmission 410. That is, there is one actual PUSCH transmission with each waveform overlapping in time domain with a slot of transmitting of the first PHR and/or the second PHR. If there is one activated serving cell, the different PUSCH transmissions of different waveforms may be transmitted by TDM in intra-slot as shown by part (a) of FIG. 4A. If there are multiple activated serving cells, the different PUSCH transmissions of different waveforms may be transmitted by TDM in intra-slot or inter-slot as shown by part (b) of FIG. 4A where the Subcarrier Spacing (SCS) of the UL active Bandwidth Part (BWP) in the first Component Carrier CC #1 and the second Component Carrier CC #2 are different. In this example, the PHR 410 is transmitted through CC #1, and the PUSCH #1 402 and the PUSCH #2 404 are transmitted through CC #2.

In some examples of the present disclosure, when there is one or more PUSCH transmissions corresponding to CP-OFDM and/or one or more PUSCH transmissions corresponding to DFT-s-OFDM that overlap with the slot in which PHR is reported, the UE may calculate the PH value for each waveform based on the first, i.e. earliest, actual PUSCH transmission among those that overlap with the slot of the PHR report corresponding to the waveform.

FIG. 4B is a schematic block diagram illustrating an example for calculation of P_{CMAX} and PHR for different waveforms in accordance with some implementations of the present disclosure. In this example, a UE is configured with two serving cells for PUSCH transmissions, where the SCS of the active UL BWP of CC #1 is 15 KHz and the SCS of the active UL BWP of CC #2 is 30 KHz. The UE provides a Type 1 power headroom report PHR 410 in a PUSCH transmission in a slot on active UL BWP of CC #1.

In CC #2, a dynamic scheduled PUSCH is transmitted with repetitions 402a and 402b (i.e., PUSCH #1 and PUSCH #2) within slot n and the indicated waveform is CP-OFDM. A configured grant PUSCH #3 404 is transmitted with DFT-s-OFDM within slot n+1. In this case both slot n and slot n+1 of CC #2 overlap with the slot of CC #1 in which the PHR 410 is reported.

Then the UE will calculate P_{CMAX} and PHR of CP-OFDM based on PUSCH #1 since it the first, or earliest, PUSCH of CP-OFDM; and will calculate P_{CMAX} and PH of DFT-s-OFDM based on PUSCH #3, which is the only PUSCH of DFT-s-OFDM.

### Case 2: There is no Actual PUSCH Transmission of a Specific Waveform That Overlaps With the Slot in Which the PHR is Transmitted

For the case where there may be one or more actual PUSCH transmissions with only a certain waveform, or the utilized waveform in current PHR transmission occasion, the P_{CMAX} and PHR corresponding to the waveform may be calculated by formula (1) based on the first actual PUSCH transmission that overlaps with the slot of the PHR report.

For the other waveform, or the non-utilized waveform in current PHR transmission occasion, since there is no actual PUSCH transmission, then how to calculate the P_{CMAX} and PH needs to be determined. The following methods are proposed.

### Method 1: the PHR for the Other Waveform is Calculated Based on Virtual PHR

Since there is no actual PUSCH transmission corresponding to the other, or non-utilized waveform in current PHR transmission occasion, the PHR may be denoted as a virtual PHR and is calculated based on formula (2).

### Method 1-1: all the Parameters for Calculation of a Virtual PHR are Predefined and are Waveform Specific

As shown in formula (2) in current standards, the related parameters in formula

(2) are predefined and are unrelated to waveform. To reflect the PH difference between different waveforms with virtual PH, different sets of parameters for calculating a virtual PH are predefined for different waveforms, for example, the modulation scheme, the RB allocation (i.e., the Edge RB allocations, Outer RB allocations or Inner RB allocations) and the number of scheduled RBs. The set of parameters may be configured the same or different for different waveforms. When a UE needs to report the P_{CMAX} and PH of the other waveform, the corresponding set of predefined parameters will be used in formula (2).

### Method 1-2: P_{CMAX} of the Other Waveform is Calculated Based on an Actual PUSCH Transmission

The P_{CMAX} of the other waveform in formula (2) is enhanced to be calculated by assuming an actual PUSCH transmission with the other waveform, and the scheduled parameters of the assumed PUSCH is the same as the real actual PUSCH transmission and other parameters, except P_{CMAX} in formula (2), are the same as specified in the standards. The values of parameters for calculating P_{CMAX} for the other waveform are same as the actual scheduled PUSCH transmission, but the interpretation of the parameters is different for different waveforms. For example, even though the MCS value of different waveforms are the same, but different modulation schemes may be determined as different MCS tables for different waveforms are specified in TS 38.214. In this example, the PHR for the non-utilized waveform in current PHR transmission occasion is a virtual PHR based on formula (2), even though the parameters are derived from the actual PUSCH of the utilized waveform.

A UE may configure its maximum output power based on the waveform of a PUSCH transmission, the RB allocation of the PUSCH transmission, the modulation scheme and so on. Thus, although P_{CMAX} for different waveforms are both calculated based on the actual PUSCH transmission, the P_{CMAX} for different waveforms may be different. Similarly, the PHRs of different waveforms are also different for not only the different P_{CMAX} but also that the PHR corresponding to the indicated waveform, or the utilized waveform, is an actual PHR while the PHR corresponding to the other waveform is a virtual PHR. Therefore, the reported different P_{CMAX} and PHR for different waveforms from a UE may assist a gNB on waveform switching.

### Method 2: the PHR for Other Waveform is Calculated Based on Actual PHR

In this method, the P_{CMAX} and the PHR of the non-utilized waveform in current PHR transmission occasion are calculated based on an assumed actual PUSCH transmission, by assuming it is to be scheduled with the same value of parameters as the current actual PUSCH transmission of the utilized waveform, according to equation (1), as an actual PHR.

The values of scheduled parameters of the assumed PUSCH transmission of the non-utilized waveform are the same as those of the actual PUSCH transmission, but the interpretation is based on the non-utilized waveform when calculating PHR for the other waveform, as in method 1-2. The P_{CMAX} of different waveforms based on the same actual PUSCH may be different as explained in method 1-2. The PH of different waveforms may also be different due to the different P_{CMAX} and the Δ_{TF,b,ƒ,c} term which is related to the modulation scheme. The different P_{CMAX} and PH may assist a gNB on waveform switching. In this method, since the PH for the other waveform is calculated based on the actual PUSCH transmission by formula (1), the following parameters should be determined:

$${M}_{RB , b , f , c}^{PUSCH} .$$

This parameter is the number of scheduled RBs of the actual PUSCH transmission. The number of scheduled RBs for PUSCH transmission with DFT-s-OFDM is multiples of 2, 3 or 5 as specified in TS 38.211. So if the actual PUSCH transmission is of CP-OFDM and the other waveform is DFT-s-OFDM, the

$${M}_{RB , b , f , c}^{PUSCH}$$

may not be multiples of 2,3 or 5. The following two methods are proposed on how to determine the value of

$${M}_{RB , b , f , c}^{PUSCH}$$

in calculation of PHK when the other waveform is DFT-s-OFDM.

As a first method, when calculating the PHR for the DFT-s-OFDM, the value of

$${M}_{RB , b , f , c}^{PUSCH}$$

of DT-s-OFDM is the largest number which is multiples of 2, 3, or 5 and is smaller than

$${M}_{RB , b , f , c}^{PUSCH} ,$$

or alternatively, the smallest number which is multiples is smaller than of 2, 3 or 5 and is larger than

$${M}_{RB , b , f , c}^{PUSCH} .$$

However, this value is only used for PHR calculation, not the real number of RBs allocated for a PUSCH transmission with DFT-s-OFDM. Another method is, when calculating PHR for DFT-s-OFDM, the number of RBs is the same as PHR calculated for CP-OFDM, that is the

$${M}_{RB , b , f , c}^{PUSCH}$$

is used without any restriction.

Δ_{TF,b,ƒ,c}. This parameter is a modulation scheme dependent offset to adjust the transmit power and it is calculated by

$${Δ}_{TF , b , f , c} ( i ) = 10 {log}_{10} ( ( {2}^{BPRE \text{?} {K}_{s}} - 1 ) \cdot {β}_{offset}^{PUSCH} )$$

$$\text{?} \text{indicates text missing or illegible when filed}$$

if deltaMCS for the serving cell is configured. Besides, Δ_{TF,b,ƒ,c}(i)=0 if the PUSCH transmission is over more than one layer. If the actual PUSCH is of CP-OFDM and is more than one layer, then Δ_{TF,b,ƒ,e}(i)=0. But for DFT-s-OFDM, since it can only support one-layer PUSCH transmission, when calculating the PHR for DFT-s-OFDM, the indicated number of layers may be assumed as one. That is, when calculating the PHR for DFT-s-OFDM, the UE shall always assume the number of layers is one and ignore the actual indicated number of layers of the actual PUSCH transmission. When the actual PUSCH transmission is CP-OFDM with more than one layers, Δ_{TF,b,ƒ,c}=0. While when calculating the PH for DFT-s-OFDM, Δ_{TF,b,ƒ,c} shall be determined by assuming a single layer transmission. For other cases, for example, when the actual PUSCH transmission is CP-OFDM with one layer or the actual PUSCH transmission is DFT-s-OFDM,

$${Δ}_{TF , b , f , c} ( i ) = 10 {log}_{10} ( ( {2}^{BPRE \text{?} {K}_{s}} - 1 ) \cdot {β}_{offset}^{PUSCH} ) .$$

$$\text{?} \text{indicates text missing or illegible when filed}$$

### Case 3: There is No Actual PUSCH Transmission Corresponding to Any Waveform That Overlaps With the Slot in Which the PHR is Transmitted

For the case where there is no actual PUSCH transmission(s) corresponding to any one of the two waveforms, namely there is no actual PUSCH transmission with CP-OFDM and there is no actual PUSCH transmission with DFT-s-OFDM as well overlaps with slot where the PHR is reported, the PHR for each waveform is a virtual PHR and is calculated by formula (2). To reflect the difference of PHR between different waveforms, method 1 in case 2 may be reused for each waveform. That is, all the parameters for calculation of a virtual PHR are predefined and are waveform specific. The parameters may include, for example, the modulation scheme, the RB allocation (i.e., the Edge RB allocations, Outer RB allocations or Inner RB allocations) and the number of scheduled RBs. The set of parameters may be configured the same or different for different waveforms.

PHR Report For Each Waveform

After a UE calculates the P_{CMAX} and PH for different waveforms, the UE shall report these values, to a gNB for waveform selection. If a UE is not configured with waveform specific PHR, the UE should select one PH and its corresponding P_{CMAX} to report.

For some examples, the UE may always report the PH and the P_{CMAX} corresponding to the indicated waveform corresponding to the first or earliest actual PUSCH transmission. Alternatively, the UE may always report the PH and the P_{CMAX} corresponding to the other waveform.

For some other examples, the UE may always report the PH and the P_{CMAX} corresponding to CP-OFDM. Alternatively, the UE may always report the PH and the P_{CMAX} corresponding to DFT-s-OFDM.

If a UE is configured to report two PHRs, for both waveforms, how a UE reports the different P_{CMAX} and PH should be determined to avoid the ambiguous understanding between the UE and the gNB.

In some examples, the UE may report the P_{CMAX} and PH for each waveform to the gNB. Alternatively, the UE may report the P_{CMAX} only for the other waveform, since the remaining terms except P_{CMAX} are the same and PH for the other waveform may be inferred or derived by gNB. That means the UE report the PH and the P_{CMAX} for the indicated waveform and report the P_{CMAX} only for the other waveform.

In some examples, whether the UE can report one PHR or two PHRs for different waveforms is determined by the UE's capability. If the UE reports that it is capable of reporting two PHRs for different waveforms, the gNB may configure the UE to report one PHR or two PHRs for different waveforms by RRC signalling.

The following methods are proposed for reporting different PHRs for different waveforms to a gNB.

Method 1: Different P_{CMAX} and/or PH for Different Waveforms are Reported in one PHR MAC-CE

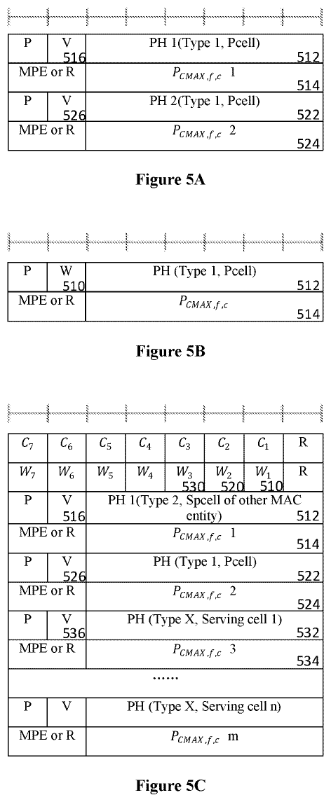

FIG. 5A is a schematic block diagram illustrating an example of one Single Entry PHR MAC-CE for PHR reporting for different waveforms in accordance with some implementations of the present disclosure.

In this example, two sets of P_{CMAX} and PHs, corresponding to CP-OFDM and DFT-s-OFDM for a serving cell, are reported in one MAC-CE. A virtual indication may be provided for each set of P_{CMAX} and PH, for indicating whether the PHR is an actual or virtual PHR. For example, the PHR MAC-CE may include, for the first waveform, a first PH 512, a first P_{CMAX} 514, and a first virtual indication 516. The PHR MAC-CE may also include, for the second waveform, a second PH 522, a second P_{CMAX} 524, and a second virtual indication 526.

To avoid the ambiguous understanding between the UE and the gNB, it should also be defined for each P_{CMAX} and/or PH the corresponding waveform. One method is that the first P_{CMAX} and/or PH, which means in the first place in the MAC-CE, or the P_{CMAX} and/or PH of foremost position in the PHR MAC-CE, is always for the indicated or configured waveform of the first PUSCH transmission that overlaps with the slot of PHR transmission; and the second P_{CMAX} and/or PH is always for the other waveform. Another method is that the first P_{CMAX} and/or PH is always for one particular waveform, e.g., CP-OFDM (or DFT-s-OFDM) and the second P_{CMAX} and/or PH is always for the other waveform, e.g., DFT-s-OFDM (or CP-OFDM).

For Multiple Entry PHR MAC-CE for PHR reporting for different waveforms in multiple serving cell, same rule as in Single Entry PHR MAC-CE is applied for PHR reporting for each serving cell. That means in each serving cell which is configured to report waveform specific PHR, different P_{CMAX} and/or PH for different waveforms is reported for each serving cell.

### Method 2: Different P_{CMAX} and PH for Different Waveforms are Reported in Separate PHR MAC-CES

FIG. 5B is a schematic block diagram illustrating an example of separate Single Entry PHR MAC-CEs for PHR reporting for a waveform in accordance with some implementations of the present disclosure.

In this method, different sets of PH and P_{CMAX} for different waveforms are reported in different MAC-CEs by separate PHR procedure. To avoid the ambiguous understanding between the UE and the gNB, a new field or the reserved field in the PHR MAC-CE may be used to indicate which PHR MAC-CE is for which waveform. In this example, the PHR MAC-CE may include a PH 512, a P_{CMAX} 514, and a waveform indication 510.

As shown in FIG. 5B, the 1-bit “W” field (i.e., the original Reserved bit) may be used for indicating for which waveform the PHR MAC-CE is reported. For example, if the “W” is “0”, it may indicate that the PHR MCA-CE including the P_{CMAX} and PH is for CP-OFDM (or DFT-s-OFDM); and if the “W” is “1”, it may indicate that the PHR MAC-CE is for DFT-s-OFDM (or CP-OFDM).

FIG. 5C is a schematic block diagram illustrating an example of one separate Multiple Entry PHR MAC-CE for PHR reporting for a waveform for UE configured with multiple serving cells in accordance with some implementations of the present disclosure. The above rule may also be applicable for a UE configured with multiple serving cells. That is, the same rule may be used for PHR reporting for a waveform in each serving cell in Multiple Entry PHR MAC-CE. The PHR is for one waveform in a serving cell, while the PHR for different serving cells may be for the same or different waveforms.

However, for Multiple Entry PHR MAC-CE, there may not be enough Reserved bits for indicating waveform, new fields of waveform indication may be introduced to indicate for which waveform the the corresponding PHR in the PHR MAC-CE is reported. Each W indicates a waveform that corresponds to the PHR for each serving cell. As shown in FIG. 5C, the Multiple Entry PHR MAC-CE may include multiple sets of PH and P_{CMAX}, for example, a first set, a second set, and a third set of PH and P_{CMAX}. The first set of PH and P_{CMAX} may include a first PH 512, a first P_{CMAX} 514, a first virtual indication 516, and a first waveform indication 510. The second set of PH and P_{CMAX} may include a second PH 522, a second P_{CMAX} 524, a second virtual indication 526, and a second waveform indication 520. The third set of PH and P_{CMAX} may include a third PH 532, a third P_{CMAX} 534, a third virtual indication 536, and a third waveform indication 530.

### PHR Triggering Event

In the current standards, if the phr-ProhibitTimer expires or has expired, and the PL has changed more than phr-Tx-PowerFactorChange dB for at least one activated Serving Cell of any MAC entity of which the active DL BWP is not dormant BWP since the last transmission of a PHR in this MAC entity when the MAC entity has UL resources for new transmission, a Power Headroom Report (PHR) shall be triggered.

The Path Loss (PL) variation for a cell is between the PL measured at the present time on the current PL-RS and the PL measured at the transmission time of the last transmission of PHR on the PL-RS in use at that time, irrespective of whether the PL-RS has changed in between.

In a legacy system, in an active serving cell, a UE only reports one PHR for the configured waveform and one PL-RS may be determined in each PHR transmission occasion. So the PL variation may be the PL change measured based on the two PL-RS in two adjacent PHRs. However, in the dynamic waveform switching scenario, different PHRs for different waveforms can be reported in each PHR transmission occasion, if the PL-RS for calculating the PHR for different waveform is different, more than one PL-RS may be measured at each PHR transmission.

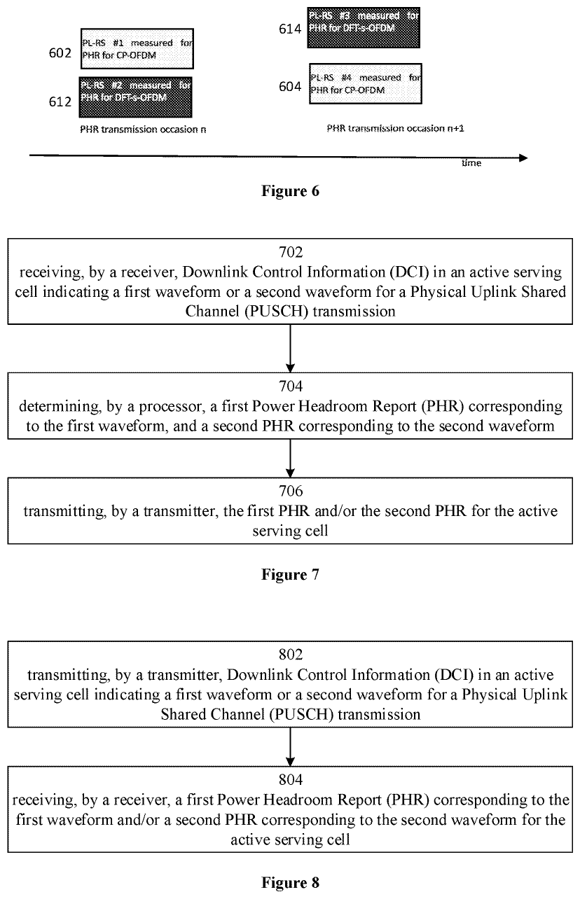

FIG. 6 is a schematic block diagram illustrating an example of Path Loss variation issue in dynamic waveforms switching in accordance with some implementations of the present disclosure. In this example, four PL-RS are determined in two consecutive PHR reporting occasions (namely PHR transmission occasion n and PHR transmission occasion n+1), with PL-RS #1 602 and PL-RS #4 604 for CP-OFDM, and PL-RS #2 612 and PL-RS #3 614 for DFT-s-OFDM. The following methods are proposed on how to define the PL variation.

Method 1: PL variation is defined within a same waveform, and when the phr-ProhibitTimer expires or has expired and if any PL variation corresponding to a waveform in a serving cell has changed more than phr-Tx-PowerFactorChange dB, PHR is triggered.

If the PL-RS used for PHR calculation for different waveforms are different, waveform specific PL variation for a cell may be defined. PL variation of a waveform is the PL measured at the present time on the current PL-RS used for PH calculation for a waveform and the PL measured at the transmission time of the last transmission of PHR on the PL-RS in use at that time for PH calculation for the same waveform. That is, the PL variation are compared between PL measured based on the two PL-RS for calculation of PHR for a same waveform. If any PL variation has changed more than Tx-PowerFactorChange dB, PHR will be triggered.

For example, as shown in FIG. 6, PL variation for CP-OFDM is defined as the PL measured based on PL-RS #4 604 and the PL measured based on PL-RS #1 602; and PL variation for DFT-s-OFDM is defined as the PL measured based on PL-RS #3 614 and the PL measured based on PL-RS #2 612. If any one of the PL variation for CP-OFDM and the PL variation for DFT-s-OFDM changes more than Tx-PowerFactorChange dB, PHR will be triggered

Method 2: PL variation is defined within a same waveform, and when the phr-ProhibitTimer expires or has expired and if PL variation of a specific waveform has changed more than phr-Tx-PowerFactorChange dB in a serving cell, PHR is triggered.

In this method, the waveform specific PL variation is the same as in method 1. However, per waveform triggering event may cause the PHR to be frequently transmitted. To reduce the overhead, it may be determined that if only a predefined one of the PL variations, for CP-OFDM or DFT-s-OFDM, change more than Tx-PowerFactorChange dB, PHR will be triggered.

Method 3: PL variation is defined between the PL measured based on the PL-RSs used to calculating the first PH (or the second PH) in the PHR MAC-CE.

In this method, PL variation is the PL measured at the present time on the current PL-RS used for the first PH calculation (or the second PH calculation) and the PL measured at the transmission time of the last transmission of PHR on the PL-RS in use at that time for the first PH calculation (or the second PH calculation) in a serving cell. The first PH is the PH in the first place in the PHR MAC-CE, or the PH of foremost position in the PHR MAC-CE, for example, the PH #1 512 as shown in FIG. 5A. When the phr-ProhibitTimer expires or has expired and if the PL variation changes more than Tx-PowerFactorChange dB, PHR will be triggered

Method 4: PL variation is defined as a maximum or minimum variation among the PL measured by the different PL-RSs.

In this method, four different PL variation candidates may be calculated, including:
1) PL31 as PL variation between the PL measured based on PL-RS #3 614 and the PL measured based on PL-RS #1 602,
2) PL32 as PL variation between the PL measured based on PL-RS #3 614 and the PL measured based on PL-RS #2 612,
3) PL41 as PL variation between the PL measured based on PL-RS #4 604 and the PL measured based on PL-RS #1 602, and
4) PL42 as PL variation between the PL measured based on PL-RS #4 604 and the PL measured based on PL-RS #2 612.

In one example, the PL variation may be defined as the minimum value among the four PL variation candidates. When the phr-ProhibitTimer expires or has expired and if the minimum value is more than Tx-PowerFactorChange dB, PHR will be triggered.

In another example, the PL variation may be defined as the maximum value among the four PL variation candidates. PHR will be triggered only if the maximum value is more than Tx-PowerFactorChange dB and the phr-ProhibitTimer expires or has expired.

FIG. 7 is a flow chart illustrating steps of reporting PHR for supporting dynamic waveform switching by UE 200 in accordance with some implementations of the present disclosure.

At step 702, the receiver 214 of UE 200 receives Downlink Control Information (DCI) in an active serving cell indicating a first waveform or a second waveform for a Physical Uplink Shared Channel (PUSCH) transmission.

At step 704, the processor 202 of UE 200 determines a first Power Headroom Report (PHR) corresponding to the first waveform, and a second PHR corresponding to the second waveform.

At step 706, the transmitter 212 of UE 200 transmits the first PHR and/or the second PHR for the active serving cell.

FIG. 8 is a flow chart illustrating steps of receiving PHR for supporting dynamic waveform switching by gNB 300 in accordance with some implementations of the present disclosure.

At step 802, the transmitter 312 of gNB 300 transmits Downlink Control Information (DCI) in an active serving cell indicating a first waveform or a second waveform for a Physical Uplink Shared Channel (PUSCH) transmission.

At step 804, the receiver 314 of gNB 300 receives a first Power Headroom Report (PHR) corresponding to the first waveform and/or a second PHR corresponding to the second waveform for the active serving cell.

In one aspect, some items as examples of the disclosure concerning UE may be summarized as follows:

1. An apparatus, Somprising:

a receiver that receives Downlink Control Information (DCI) in an active serving cell indicating a first waveform or a second waveform for a Physical Uplink Shared Channel (PUSCH) transmission;

a processor that determines a first Power Headroom Report (PHR) corresponding to the first waveform, and a second PHR corresponding to the second waveform; and

a transmitter that transmits the first PHR and/or the second PHR for the active serving cell.

2. The apparatus of item 1, wherein, upon determining by the processor that there is one or a plurality of actual PUSCH transmissions with the first waveform overlapping in time domain with a slot of transmitting of the first PHR and/or the second PHR, the first PHR is an actual PHR determined based on parameters of an earliest one of the actual PUSCH transmissions.

3. The apparatus of item 1, wherein, upon determining by the processor that there is no actual PUSCH transmission with the first waveform overlapping in time domain with a slot of transmitting of the first PHR and/or the second PHR, the first PHR is a virtual PHR determined based on a predefined set of parameters.

4. The apparatus of item 1, wherein, upon determining by the processor that there is no actual PUSCH transmission with the first waveform overlapping in time domain with a slot of transmitting of the first PHR and/or the second PHR, the first PHR is an actual PHR determined based on a predefined set of parameters.

5. The apparatus of item 3 or 4, wherein, upon determining by the processor that there is at least one actual PUSCH transmission of the second waveform overlapping in time domain with the slot of transmitting of the first PHR and/or the second PHR, the predefined set of parameters for determining the first PHR are derived from re-interpretation, based on the first waveform, of parameters indicated for the actual PUSCH transmission of the second waveform.

6. The apparatus of item 5, wherein the first and second waveforms are selected from Discrete Fourier Transform-spread-Orthogonal Frequency Division Multiplexing (DFT-s-OFDM) and Cyclic Prefix Orthogonal Frequency Division Multiplexing (CP-OFDM), and number of layers of PUSCH transmissions is assumed to be one for calculation of parameter Δ_{TF,b,ƒ,c} for PHR corresponding to DFT-s-OFDM.

7. The apparatus of item 1, wherein the processor is configured to report only one PHR; and selects one PHR, from the first and second PHRs, which corresponds to an earliest actual PUSCH transmission overlapping in time domain with a slot of transmitting of the first PHR and/or the second PHR, for transmission.

8. The apparatus of item 1, wherein the first PHR and the second PHR are reported in one PHR Media Access Control—Control Element (MAC-CE).

9. The apparatus of item 8, wherein a PHR of foremost position in the PHR MAC-CE corresponds to a waveform of an earliest actual PUSCH transmission overlapping in time domain with a slot of transmitting of the first PHR and/or the second PHR.

10. The apparatus of item 8, wherein a PHR of foremost position in the PHR MAC-CE corresponds to CP-OFDM, and a PHR of subsequent position in the PHR MAC-CE corresponds to DFT-s-OFDM.

11. The apparatus of item 1, wherein each one of the first PHR and the second PHR is reported in a separate PHR MAC-CE.

12. The apparatus of item 11, wherein the PHR MAC-CE comprises a field indicating a waveform, to which the PHR in the PHR MAC-CE corresponds.

13. The apparatus of item 1, wherein the receiver further receives a Radio Resource Control (RRC) signalling for configuring whether one PHR or a plurality of PHRs for different waveforms are to be reported.

14. The apparatus of item 1, wherein the processor further determines a Path Loss (PL) variation for each of the waveforms, and the transmitter transmits the first PHR and/or the second PHR upon determining that the PL variation exceeds phr-Tx-PowerFactorChange for the first waveform, for both waveforms, or for any of the waveforms.

15. The apparatus of item 14, wherein the PL variation for a waveform is determined based on PL measured at a present time on current Path Loss Reference Signal (PL-RS) for Power Headroom (PH) calculation of the waveform and PL measured at a transmission time of the last transmission of PHR on PL-RS in use at that time for PH calculation of the same waveform.

16. The apparatus of item 1, wherein the processor further determines a Path Loss (PL) variation, wherein the PL variation is determined based on PL measured at a present time on current Path Loss Reference Signal (PL-RS) for the first PHR and PL measured at a transmission time of the last transmission of PHR on PL-RS in use at that time for the first PHR, the transmitter transmits the first PHR and/or the second PHR upon determining that the PL variation exceeds phr-Tx-PowerFactorChange.

In another aspect, some items as examples of the disclosure concerning gNB may be summarized as follows:

17. An apparatus, comprising:

a transmitter that transmits Downlink Control Information (DCI) in an active serving cell indicating a first waveform or a second waveform for a Physical Uplink Shared Channel (PUSCH) transmission; and

a receiver that receives a first Power Headroom Report (PHR) corresponding to the first waveform and/or a second PHR corresponding to the second waveform for the active serving cell.

18. The apparatus of item 17, wherein the first and second waveforms are selected from Discrete Fourier Transform-spread-Orthogonal Frequency Division Multiplexing (DFT-s-OFDM) and Cyclic Prefix Orthogonal Frequency Division Multiplexing (CP-OFDM).

19. The apparatus of item 17, wherein the first PHR and the second PHR are received in one PHR Media Access Control—Control Element (MAC-CE).

20. The apparatus of item 19, wherein a PHR of foremost position in the PHR MAC-CE corresponds to a waveform of an earliest actual PUSCH transmission overlapping in time domain with a slot of receiving of the first PHR and/or the second PHR.

21. The apparatus of item 19, wherein a PHR of foremost position in the PHR MAC-CE corresponds to CP-OFDM, and a PHR of subsequent position in the PHR MAC-CE corresponds to DFT-s-OFDM.

22. The apparatus of item 17, wherein each one of the first PHR and the second PHR is received in a separate PHR MAC-CE.

23. The apparatus of item 22, wherein the PHR MAC-CE comprises a field indicating a waveform, to which the PHR in the PHR MAC-CE corresponds.

24. The apparatus of item 17, wherein the transmitter further transmits a Radio Resource Control (RRC) signalling for configuring whether one PHR or a plurality of PHRs for different waveforms are to be reported.

In a further aspect, some items as examples of the disclosure concerning a method of UE may be summarized as follows:

25. A method, comprising:

receiving, by a receiver, Downlink Control Information (DCI) in an active serving cell indicating a first waveform or a second waveform for a Physical Uplink Shared Channel (PUSCH) transmission;

determining, by a processor, a first Power Headroom Report (PHR) corresponding to the first waveform, and a second PHR corresponding to the second waveform; and

transmitting, by a transmitter, the first PHR and/or the second PHR for the active serving cell.

26. The method of item 25, wherein, upon determining by the processor that there is one or a plurality of actual PUSCH transmissions with the first waveform overlapping in time domain with a slot of transmitting of the first PHR and/or the second PHR, the first PHR is an actual PHR determined based on parameters of an earliest one of the actual PUSCH transmissions.

27. The method of item 25, wherein, upon determining by the processor that there is no actual PUSCH transmission with the first waveform overlapping in time domain with a slot of transmitting of the first PHR and/or the second PHR, the first PHR is a virtual PHR determined based on a predefined set of parameters.

28. The method of item 25, wherein, upon determining by the processor that there is no actual PUSCH transmission with the first waveform overlapping in time domain with a slot of transmitting of the first PHR and/or the second PHR, the first PHR is an actual PHR determined based on a predefined set of parameters.

29. The method of item 27 or 28, wherein, upon determining by the processor that there is at least one actual PUSCH transmission of the second waveform overlapping in time domain with the slot of transmitting of the first PHR and/or the second PHR, the predefined set of parameters for determining the first PHR are derived from re-interpretation, based on the first waveform, of parameters indicated for the actual PUSCH transmission of the second waveform.

30. The method of item 29, wherein the first and second waveforms are selected from Discrete Fourier Transform-spread-Orthogonal Frequency Division Multiplexing (DFT-s-OFDM) and Cyclic Prefix Orthogonal Frequency Division Multiplexing (CP-OFDM), and number of layers of PUSCH transmissions is assumed to be one for calculation of parameter Δ_{TF,b,ƒ,c} for PHR corresponding to DFT-s-OFDM.

31. The method of item 25, wherein the processor is configured to report only one PHR; and selects one PHR, from the first and second PHRs, which corresponds to an earliest actual PUSCH transmission overlapping in time domain with a slot of transmitting of the first PHR and/or the second PHR, for transmission.

32. The method of item 25, wherein the first PHR and the second PHR are reported in one PHR Media Access Control—Control Element (MAC-CE).

33. The method of item 32, wherein a PHR of foremost position in the PHR MAC-CE corresponds to a waveform of an earliest actual PUSCH transmission overlapping in time domain with a slot of transmitting of the first PHR and/or the second PHR.

34. The method of item 32, wherein a PHR of foremost position in the PHR MAC-CE corresponds to CP-OFDM, and a PHR of subsequent position in the PHR MAC-CE corresponds to DFT-s-OFDM.

35. The method of item 25, wherein each one of the first PHR and the second PHR is reported in a separate PHR MAC-CE.

36. The method of item 35, wherein the PHR MAC-CE comprises a field indicating a waveform, to which the PHR in the PHR MAC-CE corresponds.

37. The method of item 25, wherein the receiver further receives a Radio Resource Control (RRC) signalling for configuring whether one PHR or a plurality of PHRs for different waveforms are to be reported.

38. The method of item 25, wherein the processor further determines a Path Loss (PL) variation for each of the waveforms, and the transmitter transmits the first PHR and/or the second PHR upon determining that the PL variation exceeds phr-Tx-PowerFactorChange for the first waveform, for both waveforms, or for any of the waveforms.

39. The method of item 38, wherein the PL variation for a waveform is determined based on PL measured at a present time on current Path Loss Reference Signal (PL-RS) for Power Headroom (PH) calculation of the waveform and PL measured at a transmission time of the last transmission of PHR on PL-RS in use at that time for PH calculation of the same waveform.

40. The method of item 25, wherein the processor further determines a Path Loss (PL) variation, wherein the PL variation is determined based on PL measured at a present time on current Path Loss Reference Signal (PL-RS) for the first PHR and PL measured at a transmission time of the last transmission of PHR on PL-RS in use at that time for the first PHR, the transmitter transmits the first PHR and/or the second PHR upon determining that the PL variation exceeds phr-Tx-PowerFactorChange.

In a yet further aspect, some items as examples of the disclosure concerning a method of gNB may be summarized as follows:

41. A method, comprising:

transmitting, by a transmitter, Downlink Control Information (DCI) in an active serving cell indicating a first waveform or a second waveform for a Physical Uplink Shared Channel (PUSCH) transmission; and

receiving, by a receiver, a first Power Headroom Report (PHR) corresponding to the first waveform and/or a second PHR corresponding to the second waveform for the active serving cell.

42. The method of item 41, wherein the first and second waveforms are selected from Discrete Fourier Transform-spread-Orthogonal Frequency Division Multiplexing (DFT-s-OFDM) and Cyclic Prefix Orthogonal Frequency Division Multiplexing (CP-OFDM).

43. The method of item 41, wherein the first PHR and the second PHR are received in one PHR Media Access Control—Control Element (MAC-CE).

44. The method of item 43, wherein a PHR of foremost position in the PHR MAC-CE corresponds to a waveform of an earliest actual PUSCH transmission overlapping in time domain with a slot of receiving of the first PHR and/or the second PHR.

45. The method of item 43, wherein a PHR of foremost position in the PHR MAC-CE corresponds to CP-OFDM, and a PHR of subsequent position in the PHR MAC-CE corresponds to DFT-s-OFDM.

46. The method of item 41, wherein each one of the first PHR and the second PHR is received in a separate PHR MAC-CE.

47. The method of item 46, wherein the PHR MAC-CE comprises a field indicating a waveform, to which the PHR in the PHR MAC-CE corresponds.

48. The method of item 41, wherein the transmitter further transmits a Radio Resource Control (RRC) signalling for configuring whether one PHR or a plurality of PHRs for different waveforms are to be reported.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1-15. (canceled)

16. A user equipment (UE) for wireless communication, comprising:
at least one memory; and
at least one processor coupled with the at least one memory and operable to cause the UE to:
receive downlink control information (DCI) in an active serving cell indicating a first waveform or a second waveform for a physical uplink shared channel (PUSCH) transmission;
determine a first power headroom report (PHR) and a first UE configured maximum transmit power corresponding to the first waveform, and a second PHR and a second UE configured maximum transmit power corresponding to the second waveform; and
transmit, in one PHR media access control (MAC)-control element (CE) (MAC-CE) and for the active serving cell, one or more of the first PHR and the first UE configured maximum transmit power, or the second PHR and the second UE configured maximum transmit power.

17. The UE of claim 16, wherein the at least one processor is operable to cause the UE to:
determine that one or more PUSCH transmissions with the first waveform overlap in time domain with a slot for transmitting one or more of the first PHR or the second PHR; and determine that the first PHR is an actual PHR determined based at least in part on parameters of an earliest PUSCH transmission of the one or more PUSCH transmissions.

18. The UE of claim 16, wherein the at least one processor is operable to cause the UE to:
determine that there is no PUSCH transmission with the first waveform overlapping in time domain with a slot for transmitting one or more of the first PHR or the second PHR; and
determine that the first PHR is a virtual PHR determined based on a predefined set of parameters.

19. The UE of claim 16, wherein the at least one processor is operable to cause the UE to:
determine that there is no PUSCH transmission with the first waveform overlapping in time domain with a slot for transmitting one or more of the first PHR or the second PHR; and
determine that the first PHR is an actual PHR based on a predefined set of parameters.

20. The UE of claim 19, wherein the at least one processor is operable to cause the UE to:
determine that there is at least one PUSCH transmission of the second waveform overlapping in time domain with the slot for transmitting the one or more of the first PHR or the second PHR, wherein the predefined set of parameters for determining the first PHR are derived from re-interpretation, based on the first waveform, of parameters indicated for the PUSCH transmission of the second waveform.

21. The UE of claim 20, wherein the first waveform and the second waveform are selected from discrete Fourier transform-spread-orthogonal frequency division multiplexing (DFT-s-OFDM) and cyclic prefix orthogonal frequency division multiplexing (CP-OFDM), and a number of layers of PUSCH transmissions comprises one layer for calculation of parameter Δ_{TF,b,ƒ,c} for PHR corresponding to DFT-s-OFDM.

22. The UE of claim 16, wherein the UE is configured to report one PHR, and wherein the at least one processor is operable to cause the UE to:
select, for transmission, a PHR from the first PHR and the second PHR, wherein the selected PHR corresponds to an earliest PUSCH transmission overlapping in time domain with a slot for transmitting one or more of the first PHR or the second PHR.

23. The UE of claim 16, wherein:
the second waveform associated with the second UE configured maximum transmit power comprises a non-utilized waveform for a current PHR transmission occasion; and
the second UE configured maximum transmit power is calculated based at least in part on an assumed PUSCH transmission by assuming that the assumed PUSCH transmission is to be scheduled with one or more same parameter values as a current PUSCH transmission of the first waveform, wherein the first waveform comprises a utilized waveform for the current PHR transmission occasion.

24. The UE of claim 16, wherein a PHR in foremost position in the PHR MAC-CE corresponds to a waveform of an earliest PUSCH transmission overlapping in time domain with a slot for transmitting one or more of the first PHR or the second PHR.

25. The UE of claim 16, wherein a PHR in a foremost position in the PHR MAC-CE corresponds to cyclic prefix orthogonal frequency division multiplexing (CP-OFDM), and a PHR in a subsequent position in the PHR MAC-CE corresponds to discrete Fourier transform-spread-orthogonal frequency division multiplexing (DFT-s-OFDM).

26. The UE of claim 16, wherein:
the first UE configured maximum transmit power is in a foremost position in the PHR MAC-CE and corresponds to an indicated waveform of a PUSCH transmission that overlaps with a slot for PHR transmission; and
the second UE configured maximum transmit power corresponds to the second waveform.

27. The UE of claim 16, wherein the at least one processor is operable to cause the UE to:
determine a path loss (PL) variation for each of the first waveform and the second waveform; and
transmit one or more of the first PHR or the second PHR based at least in part on determining that the PL variation exceeds phr-Tx-PowerFactorChange for one or more of the first waveform or the second waveform.

28. The UE of claim 27, wherein the PL variation for a waveform is determined based at least in part on PL measured at a first time on current path loss reference signal (PL-RS) for power headroom (PH) calculation of the waveform, and PL measured at a transmission time of a last transmission of PHR on PL-RS in use at the transmission time for PH calculation of the waveform.

29. The UE of claim 16, wherein the at least one processor is operable to cause the UE to:
determine a path loss (PL) variation based at least in part on PL measured at a first time on current path loss reference signal (PL-RS) for the first PHR, and PL measured at a transmission time of a last transmission of PHR on PL-RS in use at the transmission time for the first PHR; and
transmit one or more of the first PHR or the second PHR based at least in part on determining that the PL variation exceeds phr-Tx-PowerFactorChange.

30. The UE of claim 16, wherein the at least one processor is operable to cause the UE to:
receive, via radio resource control (RRC) signaling, a configuration to configure the UE to report two or more PHRs for two or more waveforms.

31. A method performed by a user equipment (UE), the method comprising:
receiving downlink control information (DCI) in an active serving cell indicating a first waveform or a second waveform for a physical uplink shared channel (PUSCH) transmission;
determining a first power headroom report (PHR) and a first UE configured maximum transmit power corresponding to the first waveform, and a second PHR and a second UE configured maximum transmit power corresponding to the second waveform; and
transmitting, in one PHR media access control (MAC)-control element (CE) (MAC-CE) and for the active serving cell, one or more of the first PHR and the first UE configured maximum transmit power, or the second PHR and the second UE configured maximum transmit power.

32. The method of claim 31, wherein:
the second waveform associated with the second UE configured maximum transmit power comprises a non-utilized waveform for a current PHR transmission occasion; and
the second UE configured maximum transmit power is calculated based at least in part on an assumed PUSCH transmission by assuming that the assumed PUSCH transmission is to be scheduled with one or more same parameter values as the current PUSCH transmission of the first waveform, wherein the first waveform comprises a utilized waveform for the current PHR transmission occasion.

33. The method of claim 31, wherein:
the first UE configured maximum transmit power is in a foremost position in the PHR MAC-CE and corresponds to an indicated waveform of a PUSCH transmission that overlaps with a slot for PHR transmission; and
the second UE configured maximum transmit power corresponds to the second waveform.

34. A network equipment (NE) for wireless communication, comprising:
at least one memory; and
at least one processor coupled with the at least one memory and operable to cause the NE to:
transmit downlink control information (DCI) in an active serving cell indicating a first waveform or a second waveform for a physical uplink shared channel (PUSCH) transmission; and
receive, in one power headroom report (PHR) media access control (MAC)-control element (CE) (MAC-CE) and for the active serving cell, one or more of:
a first PHR corresponding to the first waveform and a first UE configured maximum transmit power; or,
a second PHR corresponding to the second waveform and a second UE configured maximum transmit power.

35. A method performed by a network equipment (NE), the method comprising:
transmitting downlink control information (DCI) in an active serving cell indicating a first waveform or a second waveform for a physical uplink shared channel (PUSCH) transmission; and
receiving, in one power headroom report (PHR) media access control (MAC)-control element (CE) (MAC-CE) and for the active serving cell, one or more of:
a first PHR corresponding to the first waveform and a first UE configured maximum transmit power; or
a second PHR corresponding to the second waveform and a second UE configured maximum transmit power.
